(19) United States
(12) Patent Application Publication
(10) Pub. No.: US 2018/0315562 A1
(43) Pub. Date: Nov. 1, 2018

(54) Light Switch Adapter

(71) Applicant: THE GOVERNORS OF THE UNIVERSITY OF ALBERTA, Edmonton (CA)

(72) Inventor: Keith Kentigern Fenrich, Edmonton (CA)

(21) Appl. No.: 15/962,958

(22) Filed: Apr. 25, 2018

Related U.S. Application Data
(60) Provisional application No. 62/490,126, filed on Apr. 26, 2017.

(51) Int. Cl. H01H 23/14; H01H 23/04

(52) U.S. Cl. CPC H01H 23/141; H01H 23/24; H01H 23/04

(57) ABSTRACT

A light switch adapter for actuating a light switch having a switch actuator movable between on and off positions includes an adapter stationary member removably mountable in fixed relation to the light switch, an adapter actuator movably attached to the adapter stationary member for moving relative to the adapter stationary member between on and off positions, and a pair of cords that engage the adapter actuator. The adapter actuator is responsive to pressure applied to its surfaces, and to increased tension in the cords to move to its off and on positions. The adapter actuator engages the switch actuator to urge the switch actuator to its off and on positions as the adapter actuator moves to its off and on positions. An adaptive interface member facilitates the application of increased tension to the cords. A computer system allows for monitoring use of the light switch adapter.

### TECHNICAL FIELD

The present invention relates to light switch adapters for actuating light switches, and more particularly, light switch adapters suitable for use by persons having impaired motor control, strength, reach, or limited range of motion to operate light switches such as children or persons with disabilities.

### BACKGROUND OF THE INVENTION

Conventional light switches are typically mounted on walls at about 1.2 m above floor level, and require a moderate level of arm, wrist, hand, and finger strength and motor control for effective operation.

People may be challenged in operating conventional light switches for a variety of reasons. For example, neurological disorders may result in a loss of fine motor control and/or range of arm and/or hand motion. People who use support devices such as canes or walkers may risk falling when raising their hands off of the support device to operate a light switch. Light switches may be out of reach of young children, shorter adults, wheel users, and people with amputated or underdeveloped arms.

One solution to this problem is to reposition light switches at a lower height by alteration of electrical and wall infrastructure. However, this is relatively complicated, expensive, and difficult to reverse. Further, the resulting placement of the light switch may be suboptimal for persons of average size and reach. Further still, repositioning light switches does not directly address challenges that are unrelated to the user's limited reach. Such considerations may ultimately weigh against relocating light switches.

Accordingly, there remains a need in the art for light switch adapters to facilitate use of conventional light switches by a variety of users. Preferably, such light switch adapters are economical, convenient to install, removable, safe to use, neat in appearance, and customizable for users having different needs.

### SUMMARY OF THE INVENTION

In one aspect, the present invention comprises a light switch adapter for actuating a light switch comprising a switch actuator movable between a switch actuator off-position and a switch actuator on-position. The light switch adapter comprises an adapter stationary member, an adapter actuator, an off-cord, and an on-cord. The adapter stationary member is removably attachable either directly or indirectly to the light switch, and in fixed relation to the light switch. The adapter actuator is movably attached to the adapter stationary member. Movement of the adapter actuator relative to the adapter stationary member to an adapter actuator off-position and an adapter actuator on-position urges the switch actuator to the move to the switch actuator off-position and the switch actuator on-position, respectively. Both the off-cord and the on-cord engage the adapter actuator. The adapter actuator is responsive to both pressure applied to an adapter actuator off-surface and increased tension in the off-cord to move to the adapter actuator off-position, and thereby move the switch actuator to the switch actuator off-position. The adapter actuator is responsive to both pressure applied to an adapter actuator on-surface and increased tension in the on-cord to move to the adapter actuator on-position, and thereby move the switch actuator to the switch actuator on-position.

In one embodiment, the adapter actuator is shaped to engage a substantially planar switch actuator off-surface and a substantially planar switch actuator on-surface.

In one embodiment, the light switch adapter is used with the light switch mounted in a wall receptacle, and the adapter stationary member comprises a cover plate for covering the wall receptacle.

In one embodiment, the light switch adapter further comprises an adaptive interface member for facilitating application of the increased tension to the off-cord or application of the increased tension to the on-cord. In one embodiment, the adaptive interface member may comprise a light switch emulator.

In one embodiment, the light switch adapter further comprises a computer-implemented system for monitoring use of the light switch. The computer-implemented system comprises a sensor device, a processor, and a memory. The sensor device generates a sensor signal indicative of one or a combination of: a movement of the adapter actuator; and a force applied to one or a combination of: the adapter actuator, the off-cord; and the on-cord. The processor is operatively connected to the sensor device and the memory. The memory comprises a non-transitory medium readable by the processor to implement a method comprising the steps of: generating data indicative of the use of the light switch adapter based on the sensor signal; and taking a related action comprising one or a combination of: storing the data in the memory; and transmitting the data via a communications network.

### BRIEF DESCRIPTION OF DRAWINGS

In the drawings, like elements are assigned like reference numerals. The drawings are not necessarily to scale, with the emphasis instead placed upon the principles of the present invention. Additionally, each of the embodiments depicted is but one of a number of possible arrangements utilizing the fundamental concepts of the present invention. The drawings are briefly described as follows:

FIG. 1 is a front elevation view of an exemplary embodiment of a wall-mounted rocker light switch in the prior art, which may be actuated by the light switch adapter of the present invention;

FIGS. 2A and 2B are isometric views of one embodiment of a light switch adapter of the present invention, as viewed from the front and the back, respectively;

FIGS. 3A and 3B are exploded isometric views of another embodiment of a light switch adapter, shown without the on-cord and the off-cord, as viewed from the front and the back, respectively;

FIGS. 3C and 3D are front isometric views of the light switch adapter shown in FIGS. 3A and 3B, shown without the on-cord and the off-cord, and with the adapter actuator in the adapter actuator on-position and the adapter actuator off-position, respectively;

FIG. 4 is a front isometric view of another embodiment of the light switch adapter of the present invention, shown without the on-cord and the off-cord, for use with an array of two light switches;

FIGS. 5A to 5D are front isometric views of embodiments of the light switch adapter of the present invention with different interchangeable adaptive interface members;

FIG. 6 is a front isometric view of another embodiment of a light switch adapter of the present invention with an adaptive interface member in the form of a light switch emulator;

FIG. 7 is an exploded front isometric view of the light switch emulator shown in FIG. 6;

FIG. 8 is an exploded perspective view of another adaptive interface member in the form of another embodiment of a light switch emulator, showing a front view of the emulator stationary member and a rear view of the emulator actuator;

FIG. 9 is a schematic drawing of a computer-implemented system of the present invention comprising a light switch adapter of the present invention; and

FIG. 10 is a flow chart showing a computer-implemented method of the present invention, using a computer-implemented system of the present invention comprising a light switch adapter of the present invention.

### DETAILED DESCRIPTION

The present invention is now described by way of exemplary embodiments and uses, having regard to the accompanying drawings. Features shown in one exemplary embodiment or may be combined with and adapted for features of another exemplary embodiment or use. The exemplary embodiments and uses are intended to be illustrative of the present invention. Accordingly, various changes and modifications can be made to the exemplary embodiments and uses without departing from the scope of the invention as defined in the claims that follow.

The present invention relates to a light switch adapter for actuating a light switch, and related computer-implemented systems and methods. Any term or expression not expressly defined herein shall have its commonly accepted definition understood by a person skilled in the art.

As used herein for convenient reference only, the terms “front”, “forward” and the like refer to the direction of the light switch facing toward the user, whereas the terms “back”, “backward”, “rear”, “rearwards” and the like refer to the direction of the light switch facing away from the user.

In the following description, various paired components or operating states of the light switch and light switch adapter of the present invention are described by prefix qualifiers “on-” and “off-”. It will be understood that such qualifiers are used to notionally distinguish the constituent components or operating states of the pair from each other by association with different selectable states of an electrical circuit operated by the light switch. For example, in the below description and accompanying drawings, components or operating states qualified by “on-” and “off-” may be associated with the closed state and open state, respectively, of the electrical circuit. Alternatively, the components or operating states qualified by “on-” and “off-” in the below description and accompanying drawings may be reversed so as to be associated with the open state and the closed state, respectively, of the electrical circuit.

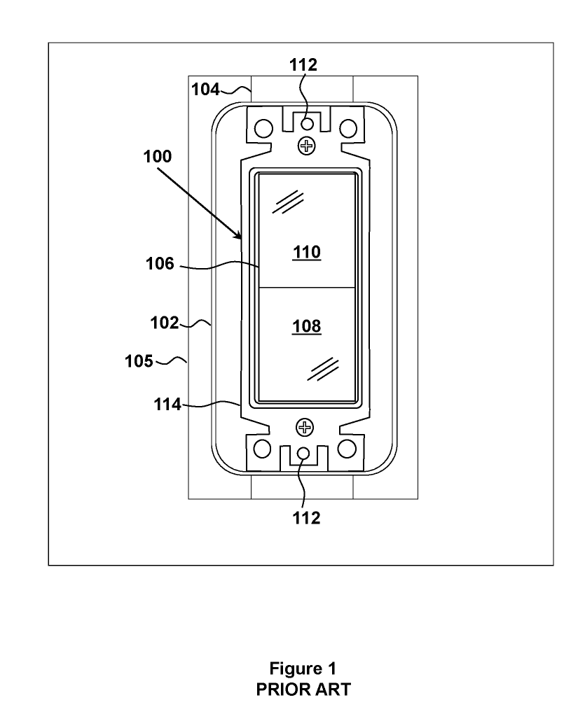

Light switch. FIG. 1 shows an exemplary embodiment of a wall-mounted light switch (100) in the prior art, which may be actuated by the light switch adapter (10) of the present invention. The exemplary embodiment of the light switch (100) is commonly used in North America and variously referred to as a rocker light switch, panel light switch, or a decorator light switch, and may be marketed under the tradename Decora™ (Leviton Manufacturing Co., United States). The embodiment of the light switch shown in FIG. 1 is provided for illustrative purposes only and does not limit the light switch adapter (10) of the present invention, which may be adapted for use with other types of rocker light switches, as well as toggle light switches (i.e., light switches actuated by a lever mechanism), in accordance with the principles described below.

In the exemplary embodiment shown in FIG. 1, the light switch (100) is mounted in an electrical receptacle box (102), which is attached to a framing member (104) of a wall, within a wall receptacle, (105) in accordance with conventional construction practices. The light switch (100) comprises a switch actuator (106) that pivots relative to the remainder of the light switch (100) between a switch actuator off-position and a switch actuator-on position, to open and close an electrical circuit that powers a light bulb. The switch actuator (106) is moved to the switch actuator off-position and the switch actuator on-position by applying pressure to a substantially planar lower switch actuator off-surface (108) and a substantially planar upper switch actuator on-surface (110), respectively. Conventionally, the electrical receptacle box (102) is concealed by a cover plate (not shown) that is attached with screws that pass through holes in the cover plate and aligned holes (112) of a light switch mounting bracket (114). Such a cover plate is removed for installation of the exemplary embodiment of the light switch adapter (10), as described below.

Light Switch Adapter.

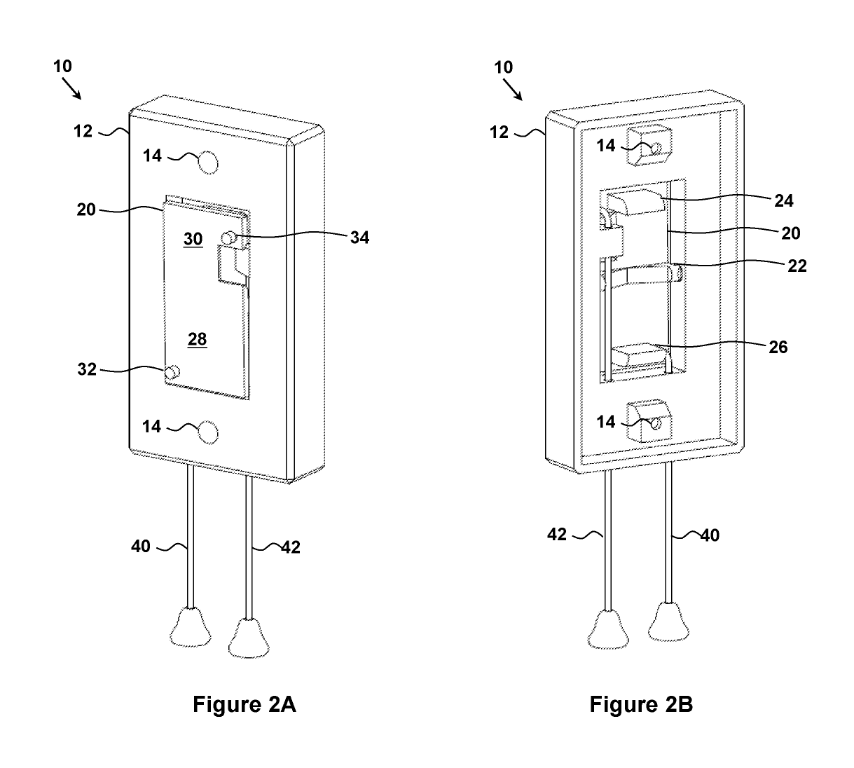

FIGS. 2A to 2B show one embodiment of a light switch adapter (10) of the present invention. The light switch adapter (10) generally comprises an adapter stationary member (12), an adapter actuator (20), an off-cord (40), and an on-cord (42). In an exemplary embodiment, the adapter stationary member (12) and the adapter actuator (20) may each be made of plastic, and may be formed by processes such as injection molding, 3D-printing, or other suitable plastic forming processes known to persons skilled in the art. In other embodiments, these components may be made of other suitable materials known in the art including, without limitation, wood, bamboo and other renewable materials, carbon fiber, metals, alloys, composites, stone, glass, natural polymers, and synthetic polymers, and formed by other processes known to persons skilled in the art. The off-cord (40) and the on-cord (42) may comprise a cord, cable, string, rope or other like member having an appropriate diameter, tensile strength, and friction properties suitable for their function described below. In an exemplary embodiment, the off-cord (40) and the on-cord (42) may be made of braided nylon, such as the kind used for mason's line.

Adapter Stationary Member.

The adapter stationary member (12) is removably attachable either directly or indirectly to the light switch (100), and in fixed relation to the light switch (100). In the exemplary embodiment, the adapter stationary member (12) has a frame-like shape that surrounds the adapter actuator (20). The adapter stationary member (12) defines a pair of mounting holes (14) that align with the mounting holes (112) formed in the light switch mounting bracket (114) to receive screws (not shown) for fastening the adapter stationary member (12) directly to the light switch (100). When so installed, the adapter stationary member (12) comprises a cover plate that covers the electrical receptacle box (102) and wall receptacle (105) shown in FIG. 1.

Adaptor Actuator.

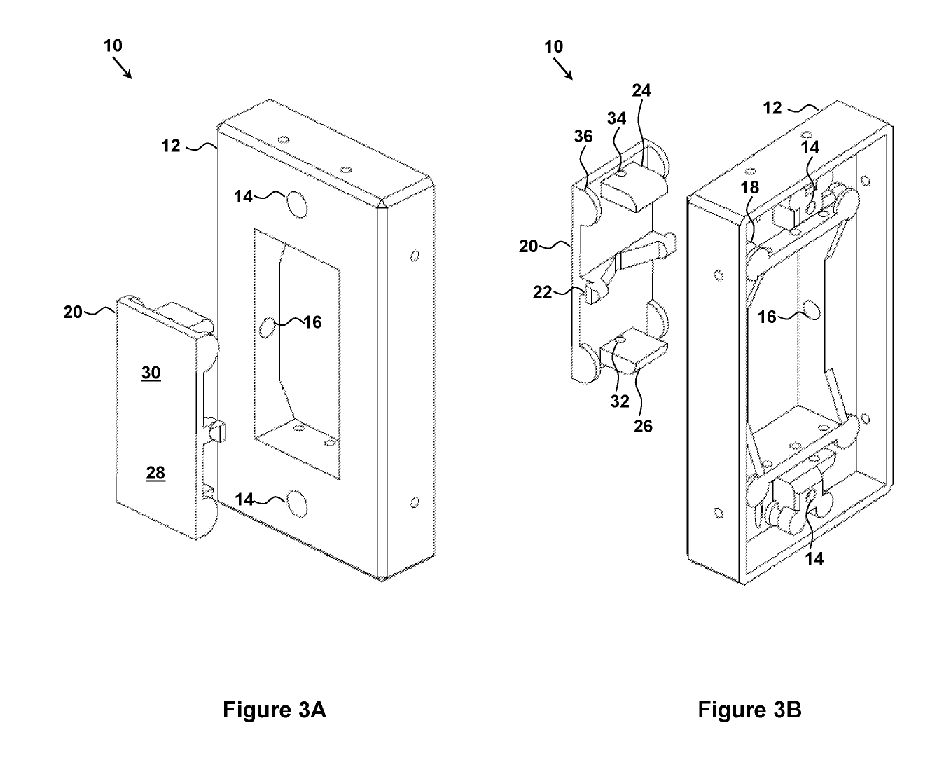

The adapter actuator (20) is movably attached to the adapter stationary member (12) for moving relative to the adapter stationary member (12). In the exemplary embodiment shown in FIGS. 2A to 3B, the adapter actuator (20) is positioned directly in front of the switch actuator (106) so that the adapter stationary member (12) and the adapter actuator (20) collectively cover the light switch (100). In the exemplary embodiment, the adapter actuator (20) is shaped to define a pair of hinge arms (22) that project sideways and insert into a pair of receiving hinge holes (16) formed in the adapter stationary member (12). This allows the adapter actuator (20) to pivot about a horizontal axis relative to the adapter stationary member (12) between an adapter actuator on-position as shown in FIG. 3C, and an adapter actuator off-position as shown in FIG. 3D. In other embodiments (not shown), the adapter actuator (20) may move relative to the adapter stationary member (12) in a different manner.

Movement of the adapter actuator (20) relative to the stationary member to the adapter actuator off-position and the adapter actuator on-position urges the switch actuator (106) to the switch actuator off-position and to the switch actuator on-position, respectively. In the exemplary embodiments shown in FIGS. 2B and 3B, the back of the adapter actuator (20) is shaped to define an upper protrusion (24) and a lower protrusion (26), which engage the switch actuator on-surface (110) and the switch-off surface (108), respectively, of the switch actuator (106) shown in FIG. 1, to translate pivoting motion of the adapter actuator (20) to the switch actuator (106).

In the exemplary embodiment, the adapter actuator (20) is sized and shaped to fit within close tolerances of the aperture formed by the frame-like adapter stationary member (12). Despite the close tolerance, it will be appreciated that a small gap may exist between the adapter actuator (20) and the adapter stationary member (12). In the exemplary embodiment shown in FIG. 3B, the adapter actuator (20) comprises semi-circular protrusions (36) formed on the back surface of the adapter actuator (20). A purpose of the protrusions (36) is to limit horizontally wiggling movement of the adapter actuator (20) within the aperture of the adapter stationary member (12) so that the pivoting movement of the adapter actuator (20) relative to the adapter stationary member (12) is unimpeded by friction between the sides of the adapter actuator (12) and the adapter stationary member (20). Another purpose of the protrusions (36) is to limit objects (e.g., a user's skin on a fingertip) from being pinched in the gap between the adapter actuator (20) and the adapter stationary member (12). In other embodiments, the protrusions (36) could have different shapes and configurations.

The adapter actuator (20) comprises an adapter actuator off-surface (28) and an adapter actuator on-surface (30), which are used to actuate the adapter actuator (20). In the exemplary embodiment shown in FIGS. 2A to 3D, the adapter actuator off-surface (28) and the actuator on-surface (30) comprise a lower portion and an upper portion, respectively, of the front surface of the adapter actuator (20). In the exemplary embodiment, the adapter actuator (20) may be dimensioned so that the adapter actuator off-surface (28) and the actuator on-surface (30) are the same or substantially the same size as the switch actuator off-surface (108) and the switch actuator on-surface (110). In other embodiments, not shown, the adapter actuator (20) may be dimensioned so that one or both of the adapter actuator off-surface (28) and the adapter actuator on-surface (30) may be larger than the switch actuator off-surface (108) and the switch actuator on-surface (110) to assist a user with targeting the adapter actuator off-surface (28) and the adapter actuator on-surface (30).

When a pressure is applied to the adapter actuator off-surface (28) and to the adapter actuator on-surface (30), such as by fingertip pressure, the adapter actuator (20) moves to the adapter actuator off-position and to the adapter actuator on-position, respectively, thereby moving the switch actuator (106) to the switch actuator off-position and the switch actuator on-position, respectively. As such, the adapter actuator (20) provides an interface that allows the switch (100) to be actuated in the same manner as a standard light switch (100).

Off-Cord and On-Cord.

The off-cord (40) and the on-cord (42) provide an alternative means for actuating the adapter actuator (20), as described below. The off-cord (40) and the on-cord (42) both engage the adapter actuator (20) in such a manner as to be able to apply forces to the adapter actuator (20) when the tension in off-cord (40) and the on-cord (42) are increased, so as to move the adapter actuator (20) to the adapter actuator off-position and the adapter actuator on-position, respectively. In the exemplary embodiment shown in FIG. 2A, the off-cord (40) and the on-cord (42) are attached to the adapter actuator (20) at a lower hole (32) and an upper hole (34) formed in the front surface of adapter actuator (20). In the exemplary embodiment shown in FIG. 3B, the off-cord (40) and the on-cord (42) (omitted from view) are attached to the adapter actuator (20) at a lower hole (32) and an upper hole (34), respectively, formed in the lower protrusion (26) and the upper protrusion (24), respectively. In other embodiments, the off-cord (40) and the on-cord (42) may engage the adapter actuator (20) in other manners, so long as they can apply a force to move to the adapter actuator (20) to the adapter actuator off-position and the adapter actuator on-position, respectively. Further, the off-cord (40) and the on-cord (42) are guided around the adapter actuator (20) by grooved guide members (18) and holes formed the back side of the adapter stationary member (12). In other exemplary embodiments (not shown), the cord guides could be formed by rollers or bearings or any other low-friction interfaces. In the exemplary embodiments shown in FIGS. 2B and 3B, the on-cord (42) and the off-cord (40) exit the adapter stationary member (12) neatly through holes formed at the bottom of the adapter stationary member (12).

When the tension in the off-cord (40) and the on-cord are increased, such as by being pulled by a user, the off-cord (40) and the on-cord (42) pull on the adapter actuator (20) so as to move it to the adapter actuator off-position and to the adapter actuator on-position, respectively, and thereby move the switch actuator (106) to the switch actuator off-position and the switch actuator on-position, respectively.

Light Switch Adapter for Multi-Switch Array.

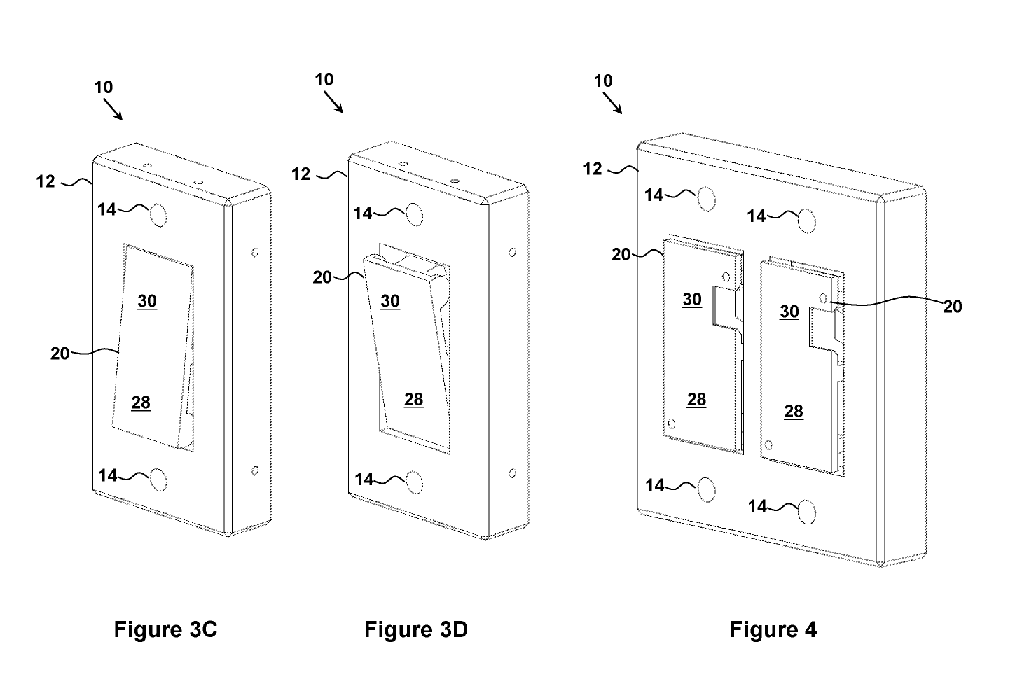

The light switch adapter (10) of the present invention may be adapted for arrays of multiple light switches. In the exemplary embodiment shown in FIG. 4, for example, a light switch adapter (10) of the present invention is adapted for an array of two light switches by providing an adapter stationary member (12) having two movably attached adapter actuators (20). Each of the adapter actuators (20) is associated with its own off-cord (40) and on-cord (42) (not shown in FIG. 4), as described above, so that the adapter actuators (20) can be independently operated.

Adaptive Interface Member.

The light switch adapter (10) may further comprise an adaptive interface member (50) attached to either the on-cord or the off-cord, or to both the off-cord (40) and the on-cord (42), to assist the user to apply pulling forces to the off-cord (40) and the on-cord (42), as the case may be.

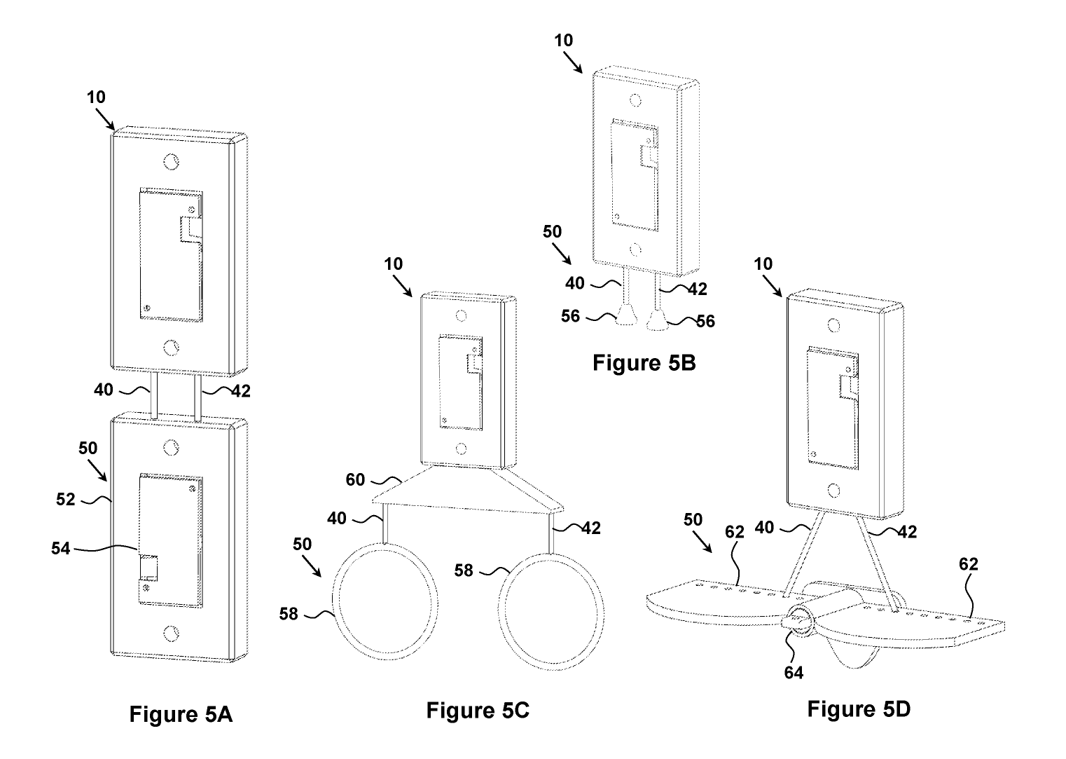

FIGS. 5A to 5D show a variety of different adaptive interface members (50) that can be interchanged to produce variants of light switch adapters (10) having the same adapter stationary member (12), adapter actuator (20), off-cord (40) and on-cord (42), so that the light switch adapter (10) can be customized for different users or adapted to changing needs of a single user.

In FIG. 5A, the adaptive interface member (50) is in the form of a light switch emulator. This adaptive interface member (50) may be suitable for users with hand and wrist function sufficient to operate a standard light switch interface, but limited reach. The adaptive interface member comprises an emulator stationary member (52) that can be removably mounted to a wall, and an emulator actuator (54) pivotally attached to the emulator stationary member (52) that is engaged by the off-cord (40) and the on-cord (42). It will be appreciated that the function of the emulator stationary member (52) and emulator actuator (54) are analogous to the structurally analogous adapter stationary member (12) and adapter actuator (20) of the light switch adapter (10), except that the emulator stationary member (52) does not cover any light switch (100) and is simply mounted at a different position on a wall, and the emulator adapter (54) does not engage any switch actuator (106). Further, in this exemplary embodiment, it will be appreciated that pressure on the lower portion and the upper portion of the front surface of the emulator actuator (54) will induce tension in the on-cord (42) and the off-cord (40), respectively. However, that this can be reversed by crossing the off-cord (40) and the on-cord (42), or by modifying the attachment points of the off-cord (40) and the on-cord (42) to the emulator actuator (54).

In FIG. 5B, the adaptive interface member comprises bell shaped toggles (56) attached to the ends of the off-cord (40) and the on-cord (42). This adaptive interface member may be suitable for persons who have good to excellent fine motor function of shoulders, arms, hands, and fingers, but are unable to reach the standard light switch.

In FIG. 5C, the adaptive interface member comprises a pair of rings (58) attached to the ends of the off-cord (40) and the on-cord (42), which are kept horizontally separated by a guide (60) for the off-cord (40) and the on-cord (42). This adaptive interface member may be suitable for persons who have impaired fine motor skills that would prevent them from grasping the toggles shown in FIG. 5B.

In FIG. 5D, the adaptive interface member comprises two levers (62) that pivot about a pivot point (64) removably attached to a wall (e.g., using hardware fasteners, glue, or removable adhesives such as 3M Command™ removable adhesive strips). This adaptive interface member may be suitable for persons that can selectively depress one of the two levers (62), but lack the fine motor skills to grasp the rings shown in FIG. 5C, or have limited strength. The levers (62) may define a plurality of spaced apart apertures, so as to allow for selectable attachment points of the off-cord (40) and the on-cord (42) to vary the leverage provided by the levers (62). In other exemplary embodiments, not shown, the adaptive interface member may comprise other mechanisms such as springs, pulleys, or elastic cords to reduce the force required to induce the tension in the off-cord (40) and the on-cord (42) necessary to actuate the light switch actuator (106).

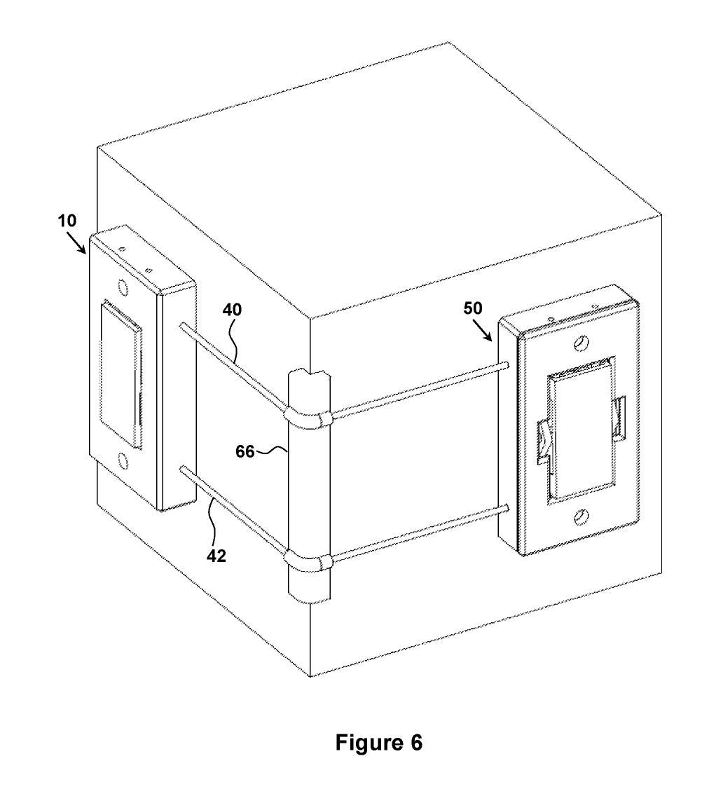

The adaptive interface member (50) can be located both vertically and horizontally away from a light switch that is located near a potential hazard (e.g., at the top of a staircase, or a stove top). In the exemplary embodiment shown in FIG. 6, the adaptive interface member (50) in the form of a light switch emulator is located around the corner form the light switch adapter (10) that covers the light switch. The off-cord (40) and the on-cord (42) pass through side holes of the adapter stationary member (12) and side holes of the emulator stationary member (52) so that the off-cord (40) and the on-cord (42) can extend horizontally between the light switch adapter (10) and the light switch emulator. A corner guide (66) is attached to the corner of the walls to avoid friction between the off-cord (40) the on-cord (42) and the walls.

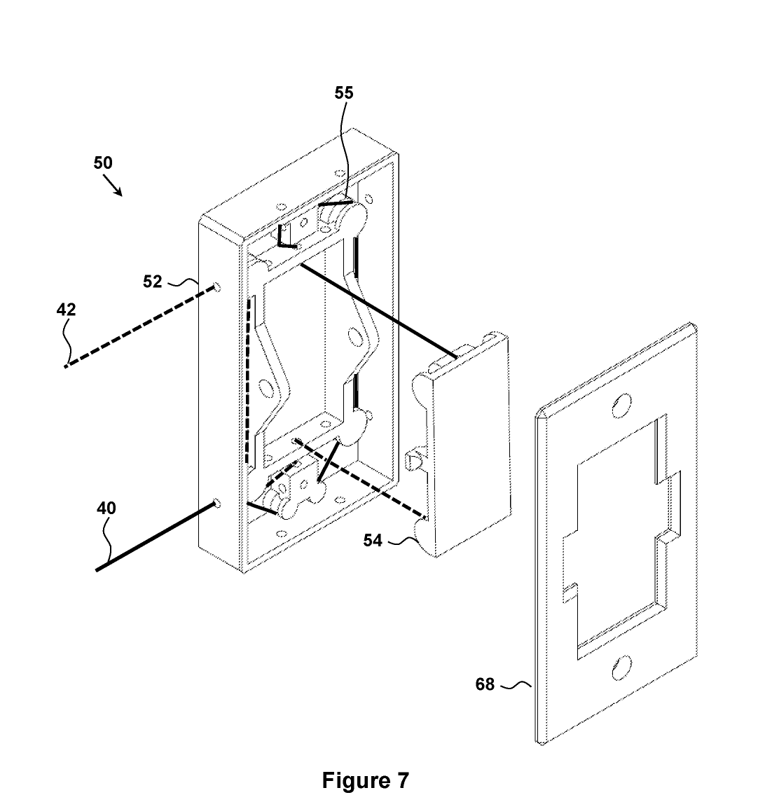

FIG. 7 shows an exploded view of the light switch emulator shown in FIG. 6. The adaptive interface member comprises an emulator stationary member (52) that can be removably mounted to a wall, an emulator actuator (54) pivotally attached to the emulator stationary member (52) that is engaged by the off-cord (40) and the on-cord (42), and an emulator cover plate (68) that is removably attachable to the emulator stationary member (52) to conceal the internal components of the light switch emulator. It will be appreciated that the function of the emulator stationary member (52) and emulator actuator (54) are analogous to the structurally analogous adapter stationary member (12) and adapter actuator (20), respectively, of the light switch adapter (10) except that the emulator stationary member (52) does not cover any light switch (100) and is simply mounted at a different position on a wall, and that the emulator actuator (54) does not engage with any light switch actuator (106). In the exemplary embodiment, the off-cord (40) (shown in solid line) is attached to the emulator actuator (54) at a hole formed in the upper protrusion formed on the back of the emulator actuator (54) so that pressing the front lower portion of the emulator actuator (54) induces tension in the off-cord (40). The on-cord (42) (shown in dashed line) is attached to the emulator actuator (54) at a hole formed in the lower protrusion formed on the back of the emulator actuator (54) so that pressing the front upper portion of the emulator actuator (54) induces tension in the on-cord (42). In this manner the relative on/off positions of the light switch actuator (106) can be preserved at the emulator actuator (54). The off-cord (40) and on-cord (42) are directed by cord guides formed by a series of grooved members (55) and holes formed by the emulator stationary member (52). In other exemplary embodiments (not shown), the cord guides may be formed by rollers or bearings or any other low-friction interfaces. In addition, the off-cord (40) and the on-cord (42) may be attached by springs (concealed from view) to the inside of the emulator stationary member (52) to maintain cord tension, and so that that pressing on the front lower and upper portion of the emulator actuator (54) is met with some resistance that emulates the tactile feedback of a standard light switch.

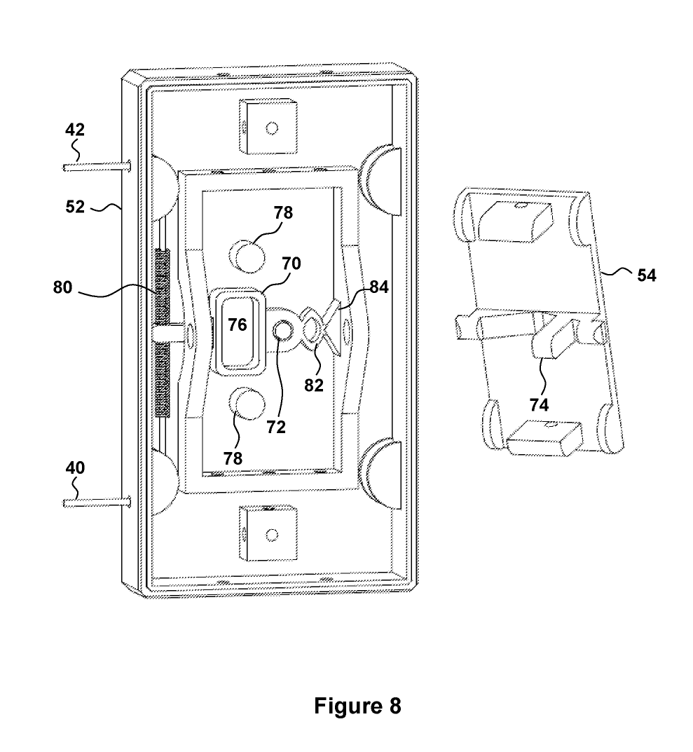

FIG. 8 shows another exemplary embodiment of an adaptive interface member in the form of a light switch emulator. Like the embodiment shown in FIG. 7, this embodiment of the light switch emulator comprises an emulator stationary member (52) that can be removably mounted to a wall, an emulator actuator (54) pivotally attached to the emulator stationary member (52) that is engaged by the off-cord (40) and the on-cord (42), and an emulator cover plate (not shown). This embodiment of the light switch emulator further comprises a lever and spring system for emulating the tactile and auditory feedback provided by a standard light switch.

The lever system includes a lever (70) that pivots about a fulcrum (72) formed by the emulator stationary member (52). The emulator actuator (54) has a rearward extending protrusion (74) that is received within an aperture (76) defined by the lever (70). As the emulator actuator (54) pivots relative to the emulator stationary member (52), the protrusion (74) urges the ends of the lever (70) to move up or down. The up or down movement of the ends of the lever (70) is limited by protrusions (78) formed by the emulator stationary member (52).

The long arm of the lever (70) (on the left side of FIG. 7) is connected to a coil spring (80), which is attached to off-cord (40) and the on-cord (42) of the light-switch adapter (10). The coil spring (80) maintains tension on the cords. In other embodiments (not shown), other types of springs and elastic members may be used in place of the coil spring (80).

The short arm of the lever (70) (on the right side of FIG. 8) is attached to a leaf spring (82). In other embodiments (not shown), other types of springs and elastic members may be used in place of the leaf spring (80). The leaf spring (82) abuts a triangular ramp (84) formed by the emulator stationary member (52), and moves against the triangular ramp (84) as the short arm of the lever (70) moves up and down in response to pushing the top or bottom of the emulator actuator (54). The force required to move the lever (70) increases as the leaf spring (82) moves over the vertex of the triangular ramp (84). Once past the vertex, the leaf spring (82) forces the lever (70) to continue in the same direction resulting in a “click” and reversible retention of the emulator actuator (54) in the last set position. It will be understood that the retention of the emulator actuator (54) in the last set position can be overcome by applying sufficient force to the emulator actuator (54) to deform the leaf spring (82) to allow for movement of the lever (70) in the opposite direction.

Computer-Implemented System and Methods.

In addition to being useful as an adaptive device and/or rehabilitation device, the light switch adapters (10) of the present invention can also be used in computer-implemented systems and methods to collect user data and/or emit signals to users (e.g., auditory, visual, and tactile signals). The data collected from the light switch adapters of the present invention may be used for clinical assessment, optimizing rehabilitation therapy, adapted interface design, and/or research purposes.

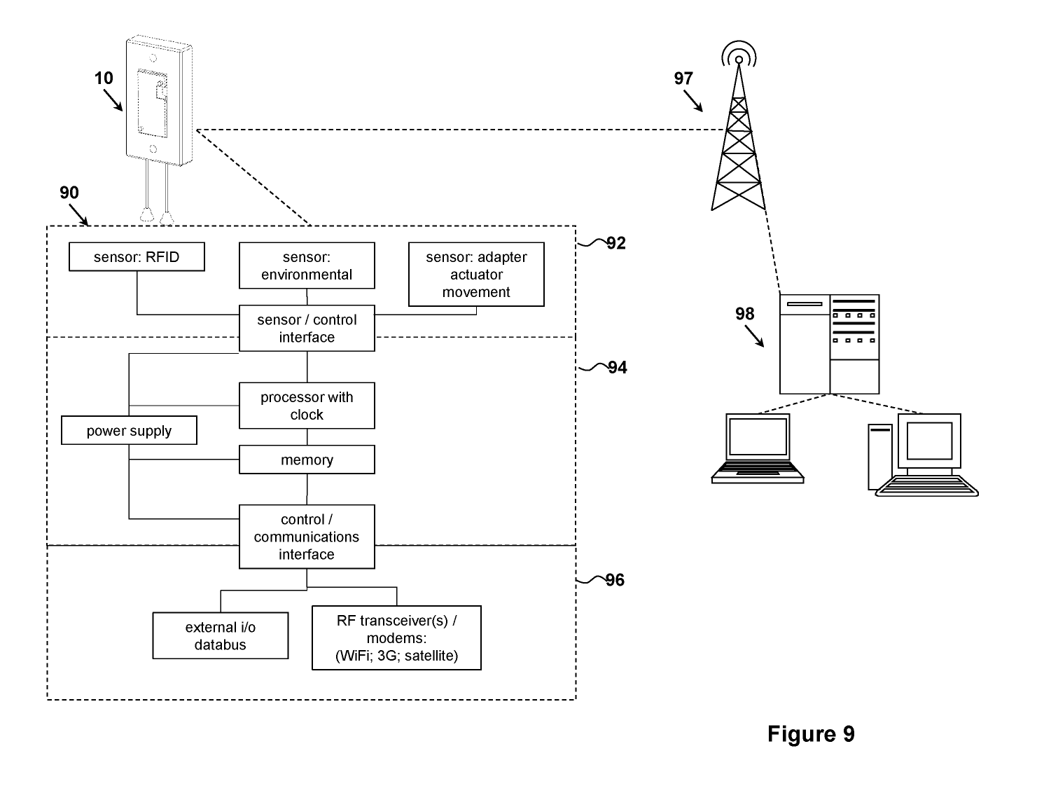

As shown in FIG. 9, the light switch adapters (10) can be operatively connected to a computer-implemented system (90) having an operatively connected power source (e.g. a battery or wired power connection), user identification module, sensor module (collectively denoted (92), control module, storage module (collectively denoted (94)), and communication module (96). The adapter stationary member may be shaped and sized to contain these module components of the computer-implemented system. It will be understood that the lines connecting the various components in FIG. 9 indicate operative connections between the components which may be wired, or wireless. Further, it will be understood that each of the components shown in FIG. 9 may be comprise a plurality of components, and that these components and the components shown in FIG. 9 may by physically discrete or physically integrated with each other.

The user identification module could include devices for identifying the user of the light switch adapter (10). Such devices may include radio frequency identification (RFID) systems, and devices for voice recognition, fingerprint identification, and/or face recognition systems.

The sensor module may include devices to detect, monitor and/or collect information relevant to the use of the light switch assembly or an environmental condition. Such devices may include force sensors, strain sensors, accelerometers, light-sensors, digital clock(s), touch sensors, temperature sensors, humidity sensors, microphones, cameras, video cameras, motion sensors, smoke sensors, carbon dioxide sensors, carbon monoxide sensors, and/or other gas sensors to monitor the status of the light switch adapter (10) (e.g., movement of its components, or forces applied to its components) and/or monitor the environmental data and/or control other electronic components of the light switch adapters (10).

The control module may include devices to process signals or data generated by the user identification module or the sensor module. The control module could include a computer processor, which in exemplary embodiments may comprise a microprocessor (i.e., a computer processor on an integrated circuit device), or a field-programmable gate array (FPGA). The control module may further comprise a computer memory comprising a non-transitory computer readable medium that stores instructions that are executable by the computer processor to control the modules, process data, and implement the methods described below, and to store data. In exemplary embodiments, the memory may comprise volatile memory (i.e., memory that requires power to maintain the stored data) as well as non-volatile memory (i.e., memory that can be retrieved after power to the memory has been cycled on and off). In exemplary embodiments, the memory may comprise solid-state flash memory, but may also comprise other types of computer readable media (e.g., magnetic media, and optical media), as known to persons skilled in the art.

The communication module could include devices to transmit and receive electronic data signals via a communications network (97) to and from a client peripheral electronic device (98) (e.g. a general purpose computer, tablet, or smart phone). The communication module may comprise an input/out databus (e.g., USB, serial port, Ethernet) for use with a wired communications network, as well as devices for use with a wireless communications network such as radio frequency (RF) signal transceivers and modems that are capable of transmitting and receiving RF signals in accordance with a variety of standards and protocols (e.g., 3G, 4G, LTE, WiFi, Bluetooth), or infrared detector. The communications network may comprise one or a combination of cable-connected buses, a local area network (LAN), a client-server network, a wide area network including the Internet, a cellular telephone network, an infrared network, or a satellite network.

The computer-implemented system could be programmed to run data collection software, control certain parameters of the light switch adapters (10) described in this disclosure, and/or run other software applications.

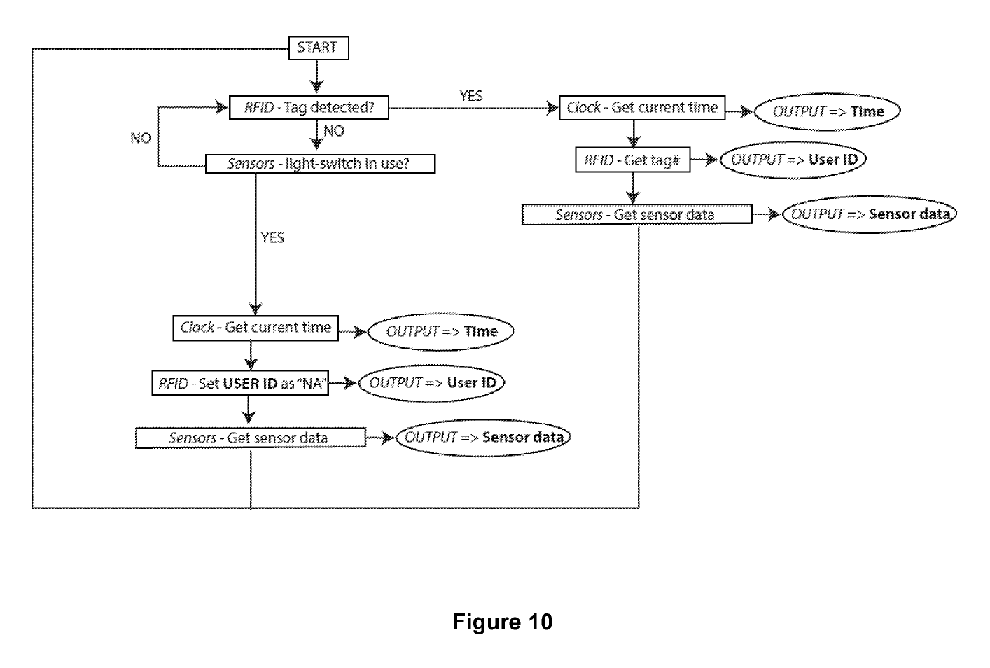

In an exemplary use illustrated in the flowchart of FIG. 10, the light switch adapters (10) and computer implemented system of the present invention could be used to collect user data to track compliance and/or the abilities of users to operate the light switch adapters (10) described in this disclosure. In this example, the user identification module has RFID capabilities and the sensor module includes variety of sensors. In this example, a user (e.g., an individual undergoing rehabilitation therapy) wears an RFID tag that distinguishes the user from other users (e.g., the tags could be located within wristbands worn by the user). The user identification module scans for RFID tags and the sensor module collects data related to the use of the light switch adapter (10). In the event an RFID tag is detected and/or the sensor data indicates that the light switch adapter (10) is in use (e.g., there is increased tension on a cord, or an applied pressure on the adapter actuator (20), and/or the adapter actuator (20) has changed position based on the sensor data received by the computer processor), then the RFID tag information and sensor data is time-stamped, stored in the computer memory, and/or transmitted to a client peripheral device (98) via the communications network (97). In this example, one or more RFID antennae can be located in or physically attached to either the adapter stationary member (12), the adapter actuator (20) and/or adaptive interface member (50) and/or any other location that would be useful for reading user RFID tags. In this example, RFID tag detection identifies the user(s). If no RFID tag is detected this indicates that a non-user (i.e., any other individual without a detectable RFID tag) is operating the light switch adapter (10). This data can also be timestamped and stored in the computer memory, and/or transmitted to a client peripheral device (98) via the communications network (97). The client peripheral device may include output devices (e.g. a display screen or a speaker) for generating a visual or audible output such as a graphical representation of the data, or a visual or audible indicator when the light switch adapter (10) is used.

In another exemplary use, the light switch adapters (10) of the present invention could be used to alert individuals of potential dangers. For example, the sensor module could include sensors for smoke, fire, carbon dioxide, carbon monoxide, and/or other potentially toxic gases. The computer implemented system may further comprise an operatively connected output device such as a speaker or a display device (e.g., a light, or computer monitor) to notify users of potential dangers. The communications module may also transmit information to client devices operated by third parties to notify them of the potential dangers.

Additional Accessories.

In embodiments, light switch adapters (10) of the present invention could include a battery and/or photovoltaic cell (i.e., solar cell) to provide power for electronic components of the light switch adapter (10) or computer-implemented system (90). In exemplary embodiments, the light switch adapters (10) could be wired directly to the power supply of the standard light switch to provide power for electronic components of the light switch adapter (10) or the computer-implemented system (90).

In exemplary embodiments, it may be useful to have indicators such as lights or sound generators integrated into the light switch adapters (10). In exemplary embodiments, the adapted interfaces could have LED lights for improved visibility of the light switch adapters and/or to indicate the location of the adapted interface (i.e., the LEDs can illuminate the light switch adapters or any of its components). In exemplary embodiments, different color LEDs could illuminate the toggles and/or adapter actuator (20) of the light switch adapters (10) to differentiate the ON and OFF toggles and/or the top and bottom or the adapter actuator (20). In exemplary embodiments, the light switch adapters (10) could be designed to have the LED indicators illuminated only in certain light levels (based on data from a light-sensor in the light switch) or at certain times (based on data from a real-time clock in the light switch adapters (10).

In exemplary embodiments, the light switch adapters (10) could include actuators and/or motors and/or electromagnets to operate the light switch adapters electronically and/or lock and/or restrict the use of the light-switch.

In exemplary embodiments, the light switch adapter (10) could have a radio transmitter/receiver, infrared detector, Bluetooth, USB, serial port, Ethernet, or any other electronic communication device integrated into the light switch adapters (10) for sending and receiving data from a light switch adapter. In exemplary embodiments, communication between a peripheral electronic device (e.g., mobile phone, remote control, laptop computer, etc.) could be established with the light switch adapters (10) to operate the light switch adapter (10) (e.g., turn on lights via activation/deactivation of actuators and/or motors and/or electromagnets). In exemplary embodiments, an electronic communication link could be established with the light switch adapter (10) to upload or download data and/or any other electronic information from the light switch adapter (10).

In some cases it might be desirable to control the forces required to operate a light switch adapter. This could be useful for controlling the “dose” of rehabilitation therapy, for accommodating individuals who cannot generate sufficient force to operate a standard light switch adapters described in this disclosure, for limiting the use of the light switch adapters (e.g., a toddler could generate the forces required to operate, but not an infant). In exemplary embodiments, the light switch adapters (10) could include mechanical elements to increase or decrease the work required to operate a light switch adapter (10). In exemplary embodiments, these mechanical elements could include brakes, actuators, motors, magnets, shifted fulcrum points in a light switch adapter or any of its components, bearings to guide cords, pulleys, etc.

The embodiments of the invention in which an exclusive property or privilege is claimed are defined as follows:

1. A light switch adapter for actuating a light switch comprising a switch actuator movable between a switch actuator off-position and a switch actuator on-position, the light switch adapter comprising:
(a) an adapter stationary member removably attachable either directly or indirectly to the light switch, and in fixed relation to the light switch;
(b) an adapter actuator movably attached to the adapter stationary member, wherein movement of the adapter actuator relative to the adapter stationary member to an adapter actuator off-position and an adapter actuator on-position urges the switch actuator to the switch actuator off-position and to the switch actuator on-position, respectively;
(c) an off-cord and an on-cord, wherein both the on-cord and the off-cord engage the adapter actuator; and
wherein the adapter actuator is responsive to both pressure applied to an adapter actuator off-surface and an increased tension in the off-cord to move to the adapter actuator off-position, and thereby move the switch actuator to the switch actuator off-position; and
wherein the adapter actuator is responsive to both pressure applied to an adapter actuator on-surface and an increased tension in the on-cord to move to the adapter actuator on-position, and thereby move the switch actuator to the switch actuator on-position.

2. The light switch adapter of claim 1 wherein the adapter actuator is shaped to engage a substantially planar switch actuator off-surface and a substantially planar switch actuator on-surface.

3. The light switch adapter of claim 1 for use with the light switch mounted in a wall receptacle, wherein the adapter stationary member comprises a cover plate for covering the wall receptacle.

4. The light switch adapter of claim 1 further comprising an adaptive interface member for facilitating either application of the increased tension to the off-cord or application of the increased tension to the on-cord.

5. The light switch adapter of claim 1 further comprising a computer-implemented system for monitoring use of the light switch, the computer-implemented system comprising:
(a) a sensor device for generating a sensor signal indicative of one or a combination of: a movement of the adapter actuator; and a force applied to one or a combination of: the adapter actuator; the off-cord; and the on-cord;
(b) a processor operatively connected to the sensor device and a memory, the memory comprising a non-transitory medium readable by the processor to implement a method comprising the steps of:
(i) generating data indicative of the use of the light switch adapter based on the sensor signal; and
(ii) taking a related action comprising one or a combination of: storing the data in the memory; and transmitting the data via a communications network.
